(19) United States
(12) Patent Application Publication
(10) Pub. No.: US 2012/0135105 A1
(43) Pub. Date: May 31, 2012

(54) TECHNIQUE OF EATING WITH THE HELP OF BRAIN SIGNALS

(76) Inventor: Yash Paul Sharma, Chandigarth (IN)

(21) Appl. No.: 13/058,821

(22) PCT Filed: Aug. 11, 2009
(86) PCT No.: PCT/IN09/00447

§ 371 Date: Mar. 8, 2011

(30) Foreign Application Priority Data
Aug. 13, 2008 (IN) 1921/DEL/2008
Dec. 24, 2008 (IN) 2933/DEL/2008

(51) Int. Cl. A23L 1/00

(52) U.S. Cl. 426/2

(57) ABSTRACT

The present invention provides a technique of eating with the help of brain signals, said technique comprising of controlling the timing of the signals sent/received by the satiety and hunger centre of brain without the use of any external medications. This results in balanced control of the blood circulation to the vital organs of the body, so that proper functioning of organs is achieved and expression of genes is regulated resulting in prevention of metabolic diseases, obesity, malnutrition, metabolic syndrome, etc.

### FIELD OF THE INVENTION

The present invention relates to a technique of eating with the help of brain signals by giving adequate time for the signals to act in the centres in the hypothalamus. More particularly, this invention provides a technique to eat with the help of brain signals so that the food is always taken according to the need. This results in avoiding overeating and improving the level of the respiration. This technique also improves the movement of the rectum and oblique muscles which leads to the reduction of abdominal and visceral fat.

### BACKGROUND AND PRIOR ART OF THE INVENTION

A person becomes obese when he/she usually takes excess of calories by eating in a faulty way (fast eating) without using his/her brain signals. In brain in the hypothalamus, there is one hunger centre and one satiety centre, which control hunger and satiety. These centres which are situated in LHA (Lateral hypothalamic area) and VMN (Veutromedial nucleous) respectively get the neuroharmonal signals through neuropeptides when we feel hunger and satiety.

In the eating pattern, when one feels hungry and eats very fast food then food is not properly chewed. It reaches the stomach fast with out proper mixing of food with enzymes. This results in an individual eating more than he/she requires, resulting in eating disorders, malnutrition, metabolic syndrome and obesity. But all these problems can be controlled by eating with the help of brain signals.

There are three types of signals:
1. Hormonal
2. Neurogenic
3. Mechanical

Normally, after overeating one feels sleepy because relatively more blood supply gets diverted from the brain, heart, lungs, eyes and other organs to the stomach intestine and splanchnic circulation. Obese people with overeating habits feel decreased intellectual functions at an early stage of life and obesity at an advanced/later stage. There is a death of neurons of hunger and satiety centre.

Reference may be made to “Chronic fatigue in developing countries: population based survey of women in India”, by Patel et al. This paper discusses the prevalence and risk factors associated with chronic fatigue, in particular to determine the association of anaemia, mental health and gender disadvantage factors with chronic fatigue. However, this paper does not teach about any technique to overcome such problems.

Reference may be made to “The nine factors that predict heart attack” by Dr. Richard N. Fogoros. This paper teaches about the factors that can predict heart attack. These factors include Smoking, Diabetes, hypertension, abdominal obesity, Stress or depression, failure to eat fruits or vegetables and lack of exercise, (one drink per day not universally accepted). However, this paper also does not teach any technique to prevent heart attack.

Reference may be made to “Responding to the threat of chronic diseases in India” by Reddy et al. This paper discusses that cardiovascular diseases and diabetes are highly prevalent in urban areas in India. Tobacco consumption is also very large. The paper discusses a national level action scheme to prevent and control such diseases. This program includes increasing awareness and educating people but there is exactly no technique described for completely preventing such diseases without the use of any medicine.

Leptin harmone is well-known in the art and its link with overweight or obesity is also known.

Reference may also be made to “Starchy diet, extra genes; Humans just keep on evolving” by Barry Starr, Stanford University. This paper discusses about a study that people who eat more starch have more amylase in their spit.

Reference may be made to “Ornish diet alters genes in prostate cancer patients”. This discussion teaches that prostate cancer patients who followed an extremely low fat diet and an exercise and stress management regimen turned on cancer preventing genes and turned off genes linked to triggering the disease. But this paper also does not teach about controlling the diet with the help of brain signals.

Reference may be made to “Serum Leptin Levels in Children with Acute Viral Hepatitis A” by Caner et al. This paper teaches about possible relation between leptin protein and cellular immunity that might affect the disease Viral Hepatitis A in children as immune response of the host determines the severity of the disease. Leptin stimulates Cytokines. But this paper also does not teach about any prevention technique.

Indian mutiny” by Jones et al. This paper teaches that chronic fatigue syndromes existed before the description of neurasthenia in 1869. These syndromes are not limited to the civilian population but occur in the military as well. However, again this paper does not teach about any prevention without the use of any medicine for Chronic fatigue syndrome.

Reference may be made to a paper “A pregnant mother's diet may turn the genes around” by Sandra Blakeslee. This paper teaches that the environmental factors like diet, stress and maternal nutrition can change gene function without altering the DNA sequence in any way. However, no such technique of eating with the help of brain signals is disclosed in this paper.

Reference may be made to “Responding to the threat of chronic diseases in India” by Reddy el al. This paper discusses that cardio-vascular, diabetes and tobacco related cancers are the most prevalent diseases in India. Hypertension is also another very common disease. There is a need to increase resource allocation and policy interventions and enhance engagement of the health system in activities related to chronic disease prevention and control.

Reference may be made to “Neuro-hormonal control of food intake; basic mechanisms and clinical implications” by Konturek et al. this paper teaches that obesity is one of the most common metabolic diseases and the greatest threats to the health because of possibility of numerous complications associated with this disease. This paper teaches about the presence of two types of centres in the hypothalamus of brain, i.e. hunger centre and satiety centre.

None of the prior art teaches the technique of present invention which is eating with the help of brain signals to prevent and control the above discussed and some other diseases without the use of any medicines.

### OBJECTS OF THE INVENTION

The main objective of the present invention is to provide a technique of eating with the help of brain signals.

A further objective of the present invention is to provide a technique of eating for controlling the signals sent/received by the satiety and hunger centre of brain without the use of any external medications.

A further objective of the present invention is to provide a technique of eating which results in balanced control of the blood circulation to the vital organs of the body, so that proper functioning of organs is achieved and expression of genes is regulated.

A further objective of the present invention is to provide a technique of eating such that the time taken while eating is increased in the range of 20 min to 50 min per meal with proper chewing and proper mixing of food particles with enzymes and hormones for better absorption.

### STATEMENT OF THE INVENTION

Accordingly, the present invention provides a technique of eating with the help of brain signals, said technique comprising of controlling the signals sent/received by the satiety and hunger centre of brain without the use of any external medications, resulting in balanced control of the blood circulation to the vital organs and rest other organs of the body, so that proper functioning of organs is achieved and expression of genes is regulated.

### DETAILED DESCRIPTION OF THE INVENTION

A person becomes obese when he usually takes excess of calories by eating in a faulty way, (fast) without using his brain signals and later on in obese patients, the neurons in the hunger centre and satiety centre degenerate. In such individuals, the only signal remains are of mechanical type, i.e. when their stomachs become full, distended and, sometimes these people feel sleepy even during eating. The blood supply from vital organs including brain, eyes, heart, lungs get relatively more diverted to the stomach, and these vital organs get deprived of the blood supply. This is the first time this concept has been described in literature.

To the two centers in the brain, signals go from the stomach and intestine by three ways. Signals from the stomach and intestine and go to these centers:
1. Hormonal—Leptin, Insulin, CCK Ghrelin.
2. Neuronal—(Vagal, Trigeminal and Sensory (Visual and taste)
3. Mechanical—(filling of stomach) distention

These signals take at least 15 to 20 minutes to reach the brain (simplified dietary intervention with brain signal) so by this time if a person eats one bread or small amount of rice or any other equivalent food. The food taken in such a way gives more energy; the signals reach the brain at appropriate time and one feels satiety, and after that one can not eat any more salads, cereals and vegetables cooked in less amount of refined oil more than the requirement. This solves many problems relating to food demand and supply, malnutrition and metabolic syndrome.

Important Points are:
1. Timing of signals
2. Leptin proper action in the hypothalamus for satiety centre. And also proper action of ghrelin on hunger centre
3. Enos Vasodilation and endrophin releafe.

When one person eats fast, he/she tends to overeat and these signals do not reach the brain at the appropriate time. By the time these signals reach brain, already overeating has taken place. Blood supply from vital organs and also from musculo skeleton system gets diverted to the stomach and intestine so as to digest this overeaten and not properly chewed food. Mechanical contraction and the work of oral cavity has to be done more to digest this food. This concept of diversion of blood supply from the vital organs to the stomach and intestine which goes waste at the expense of other organs leading to so many diseases has been described first time in literature. This has immense impact on the aetiology of various diseases, prevention, better treatment and new research in all fields of medicines and surgery.

There is no proper cure for overeating. Even the scientists, doctors and engineers and many others become victim of this overeating overweight/obesity especially central obesity (Asian obesity) which is harbinger of many diseases including myocardial infarction, sudden cardiac death, diabetic mellitus and so many other diseases (more than 100 diseases) economic burden on the country which hinders economic growth & development.

If a person eats one fourth to half of his diet with sufficient amount of cereals and vegetables (cook with less oil) with less oil, slowly in twenty to fifty minutes, this gives more energy and more efficiency along with a healthy body, less diseases as the signals to the satiety centre reach at the appropriate time and after that, no one can overeat.

Normally there is some diversion of blood supply from the vital organs to the stomach, intestine and splanchnic circulation. With over-eating this diversion becomes profound and these organs become hypoperfused and lack of nutrients also results. The person feels drowsy, which can cause postprandial angina if the person is having a coronary artery disease. Overeating also causes a remarkable diversion in blood supply leading to further hypoperfusion of the vital organs, like, postprandial hypoxia in lungs.

Atrial Fibrillation (Holiday heart syndrome), in this also demand supply mismatch occurs which is also another cause of Diversion of Blood, again caused with overeating. Also with overeating, the diaphragm becomes up and the lung volume decreases with the result hypoventilation becomes evident. Stomach gets distended abdominal muscles move less and obesity begets obesity.

By eating with the help of brain signals, the food is always taken according to the need. With the result there is never overeating and level of the respiration is always deep and there is movement of the rectus and oblique abdominus muscles which leads on to their movement and Abdominal (waist) and visceral fat decreases and waist to hip ratio becomes normal and Body Mass Index (BMI) also improves.

With overeating BMR increases which increases the heart rate, respiratory rate and thermal loss. With the result, energy loss becomes more than energy conserved and some of there persons become undernourished and underweight and cachetic despite eating more calories.

But by eating with the brain signals, these requirements for wheat/rice/equivalent reduce to ¼ to ½. Using the technique of present invention, if one takes bread in one hand preferably in the left hand and spoon in the right hand and takes small bite with the incisors and eats vegetables and cereals with pieces of salad, it takes 1½-2½ minutes for one cycle. So even half a bread or chapatti will take more than 10-15 minutes and later on 2^{nd} half can be taken depending upon the desire and if needed more can be taken. In majority of the cases, people feel satisfied and cannot eat more, thus overeating can be prevented. In result, this will improve each system of the body.

There is abnormal scanning of hunger centre and satiety centre in males and females. One should make the habit of eating by brain rather than stomach. The technique of present invention helps in eating with the help of brain signals rather than by stomach filling.

In brain in the hypothalamus, there is one hunger centre and one satiety centre. These two centres control hunger and satiety respectively. These centres get the neuro-harmonal signals through neuro-peptides when we feel hungry and satiety. In the eating pattern, when one feels hungry and eats fast, the food reaches stomach faster than it should actually reach, with less mixing of enzymes. This results in a person consuming more than the desired amount.

By eating fast, one over eats more food and more calories, and these signals do not reach the brain center at appropriate time. By the time these signals reach brain, already overeating has taken place. This results in blood supply from the vital organs (brain, eyes, heart, lungs and kidney etc.) and also from the musculo-skeleton system getting diverted to the stomach and intestine so as to digest this overeaten and not properly chewed food. Mechanical contraction and the work of oral cavity increases to digest this food. This diversion of blood supply from the vital organs to the stomach and intestine which goes waste at the expense of other organs, leads on to so many diseases. This has immense impact on aetiology of various diseases, prevention, better treatment and new research in all fields of medicines and surgery. The definition of various parameters like total calorie intake cut of line for poverty and a country to be developed nation will also change and will help in making better national and international policies.

The following are some of the problems which occur due to over-eating and the technique of present invention helps in over-coming some of the under mentioned problems without use of any medicine:

Center Nervous System (CNS): After overeating, one feels sleepy because blood supply from the brain and eyes get diverted to the stomach. People

With overeating habits and obese people face decreased intellectual functions at an early state of life and even sometimes neuronal atrophy occurs. In obese people, there is death of neurons of hunger and satiety center. There is abnormal PET scanning of hunger and satiety center in such people.

The sleepiness which occurs after overeating is usually predominately REM (rapid eye movement sleep) which is less refreshing as compared to otherwise predominately NREM sleep (non-rapid eye movement) sleep with adequate diet. This sleep even for short duration is more refreshing and natural with less of dreams and palpitations at night. Basically the brain and eyes remain well perfused with proper blood supply and glucose and less hypoxia during sleep. Eating with the help of brain signals increases the para sympathetic activity and also the sympathetic activity becomes less at night. One gets up fresh and active after sleep in the morning.

Autonomic Nervous System—There is over activity of the sympathetic system and para-sympathetic activity decreases. This activity adversely affects every system of the body and results in neuropshychiatric problems, sudden cardiac death,etc.

Eyes: Eyes also get less blood supply and hypoxia (blurring of vision) occurs which may lead on to premature presbyopia and cataract, hypertension and even blindness by metabolic factors because of diabetics etc.

Cardio vascular System (Heart): Less blood supply to heart muscles at the expense of more work (increased heart rate and contraction, to pump the blood to the stomach and intestine). With the result patient with asymptomatic angina can have angina after heavy food (post prandial angina). Person with heavy meal with or without drinks can have palpitations (atrial fibrillation). On the weekend a person takes drinks and heavy meal and hence have a more chance to develop palpitation (AF) which is known as holiday heart syndrome in medical literature.

Persons with overeating and obesity are mote prone to develop hypertension and arrhythmias. The result of angioplasty and stenting have been best seen with this technique. Even post coronary bypass surgery patients will also get benefited. There will be less chance of restenosis.

Lungs (Respiratory System): Less blood supply to the lungs with over eating and obesity there is relative hypoxemia which increases the respiratory, rate, with distended stomach the diaphragm is pushed upwards and lung size decreases and the dead space increases. There is less expansion of the lungs resulting in hypoxemia and in the long run respiratory failure and other lungs problems. This may lead on to impaired filling of the cardiac chambers which may lead on to diastolic dysfunction which ultimately lead on to LV systolic dysfunction (Heart failure).

Body Muscles (Musculo skeleton system): All the body muscles get less blood because of this diversion of blood supply and one starts feeling lethargy, fatigued and starts feeling to take rest/sleep.

Obesity: With consistent overeating (faulty and fast way of eating) there is more calorie intake which leads on to continuous weight gain. Stomach gets distended, abdominal and visceral fats increases, hepatomegaly (fatty liver). There is less movement of abdominal muscles (recto abdominis and oblique muscles). Obesity begets obesity. There are less complication dining surgery and post operative complication by controlling obesity with this technique. Need for various drugs, surgery/gyms will be less. Expenditure and time will get saved.

Metabolic Syndrome

With increased body mass indexed and waste size (more than 102 cm in males and 88 in females)

Hypertension (B.P. 140/90)

Blood Glucose 110 mg %

Triglycerides>150

HDL<15 in females and <45 in males

Out of the five, if these three are present, a person is labeled as metabolic syndrome which has a predisposes to Diabetic Mellitus, Hypertension atherosclresis, Coronary artery disease, Cerbrovascular stroke (Thrombotic and hemorrhagic), endothelial dysfunction with sluggish flow in the vessels leading on to the thrombus formation in the vessel with death of the distal organ (heart attack, bruin stroke, gangrene etc.)

Aging: In fact with improper distribution of the blood supply, hypoxic state and other metabolic factors, there is early greying of hairs, double chin, dermatology problems, and early Aging. In fact life span decreases by approximately ten years. By eating through signals with this technique one can delay the process of aging and can increase the life expectancy by more than 10 (10-20 years). In fact a person dying of premature heart attack at the age of 25-40 years the life expectancy will increase by more than 35 years.

Psychosocial and Sexual Dysfunction: Depression, anxiety, irritable behavior, learning disability in kids, decreased intellectual capacity in the kids and in the adult, decreased IQ intelligence quotient attempt to suicides etc, become more with overeating and obesity. All this will be reduced to a significant extent by eating through brain signals by keeping the body hypoxia free and better nutrition to the brain and less of sympathetic state of mind. When a person is depressed or taking drugs (sedatives or anti depressants), alcohol, these centers become insensitive leading on to weight gain and obesity. In morbid obesity there is nil movement of abdominal muscles leading on to increased waste size and various metabolic changes erupt from this change.

Immunological problems: There is productive of high CRP, interleukins 6 and TNF-alpha (Tumor, Neuroses factor) and various other inflammatory markers, some of the markers associated with malignancy. All these decrease the immunity and leads on to so many systemic problems. In fact morbid obesity is like a time bomb, which can burst any time and is a storehouse of various bad genes.

There will be less of cancers in the society first because of decreased weight related with some malignancies and secondly there will be decreased pesticides use for crops by the farmers because of improved demand supply ratio.

Nutrition and genes: There are so many genes which get expressed with nutrition pattern and obesity like TNF alpha, CRP gene, Amylase, Lipase, LDL, Malanyl COA, Insulin gene, metabolic, onco genes, neuropsychiatric genes etc. which get transmitted to the generations. In fact when kids see the parents eating pattern of parents they also learn the same and become habitual of faulty way of eating.

Infections, and eating pattern: It leads on to many infections both systemic microbial and fungal infections of the skins. It has been observed that if one eats slowly and even half to ¼ of his normal food, then these signals all hormonal, neuronal and mechanical go at the appropriate time and satiety center gets adequate signals and one feels satisfied without compromising the blood supply to any other organ. The food taken in such a way will give more satiety and one will not feel hungry. So time taken for food intake from 20 to 50 minutes and proper chewing can reduce the chances of so many diseases and can increase the life expectancy at least by more than ten years.

First obese persons can decrease their food intake to half and then to ⅓^{d} to ¼′″ (even less in some cases) amount. This will solve the problem of under nutrition as food will be surplus in amount. This will bring prosperity in the country as first of all there will be direct saving of food and then indirect saving because of decreased burden of so many diseases. Moreover, there will be saving of electricity and gas. With the result the remaining patients with diseases will be provided with best treatment in the best hospitals. This will give rise to food security and other national securities. It will increase the GOP, per capita income, intelligence and India/developing country can become developed country by 2015 and developed countries more peaceful.

Dermatological and skin color/complexion: Just in few days with the blood supply and proper nutrition to the face, decreased malanyl COA production can even lessen the dark complexion of the face which starts changing to less dark complexion and slowly fair complexion and glow comes on the face of a person. This can bring contentment, peace, prosperity and tranquility in human beings which would ultimately bring national and international peace and prosperity.

Chest and Abdomen: When abdomen is distended and obese, there is less movement of the diaphragm and less lung expansion, with the result there is tachypnoea and tachycardia. But once the abdominal obesity starts decreasing, the chest excursion increases and also, the movement of the abdomen muscles rectum and obliques starts. This results in reduction in abdominal fat just because of continuous movement (exercise) of the abdominal muscles with each inspiration. Normally there is 20000-25000 cycles of respiration per day.

In obese people, because of abdominal distension, there is less movement of the muscles so that fat starts accumulating and obesity begets obesity.

In people who are not obese, the respiration is deep and the diaphragmatic movements are proper. Upward and downward movement of the diaphragm occur and there is a normal lung expansion, with the result the tidal volume and vital capacity increases of the dead space in the lungs becomes less. This in fact makes the movements of the abdominal muscles Rectus and oblique and there is automatic activity (exercise) of these muscles which makes them stronger and fat free. The habit of deep breathing and concentrating on one's respiration occurs which can decrease many physical and mental diseases. This results in tranquility in mind.

This technique will have direct applications for various diseases and indirect applications in our society in the following ways:

Nature and Environment:

There will be less of deforestation and water scarcity. The water level will not go deeper, it may rise. The nature will also become cool, calm and less of natural devastating and disasters. Money can be diverted to other social activities and securities of health education, jobs and so on for development in other sectors. The developing country will be developed faster. There will be a lot of savings of resources which can be contributed towards help of needy and other developing countries with the surplus resources. There will be change in GDP demand and supply mismatch of food and so many related articles, total calorie intake of a person definition of poverty and prosperity in a country by the planning commission. There will be lot of saving of expenditures in all the Ministries including but not limited to Ministry of Health, Food, Agriculture, Defense, Commerce, Social and Empowerment Justice, Law Ministry, Energy both renewable and non renewable etc. No one in this universe will remain hungry, poor or deprived of any social security. All classes, politicians, judiciary, bureaucrats, medical and engineering, businessman, technical staff, young (school kids) persons living in abroad all wilt be benefited once they will come to know about the simple and novel concept of eating through brain signals.

Asian Obesity and Hypertriglyceridemia

Asian in particular are more prone to DM, HTN and cardiac ailment (Heart Attacks). When a person leads a stressful life, incidences of heart attack increases. So many studies have shown that mortality is more in the Indians living abroad in different countries. It has been postulated that this is because of thrifty genes theory. The main cause is over nutrition and excessive calories diet. If concept of hunger center and satiety center is kept in mind, the mortality can decreased by more than 50-75% approkimately which will have a lot of saving in all countries and also in Asians living abroad.

Asians are more prone to metabolic syndrome. There are a lot of theories of accelerated arteriosclerosis and DM and Heart Diseases in Indian and Asian (NRI) living abroad. Barker's hypothesis i.e. when during intrauterine life there is less of nutrition to the mother and to the child. After birth under nutrition child gets normal food later on during life than many problems of obesity, hypertension, diabetics mellitus and premature arteriosclerosis develop in that child. At one stage there may have been food starvation in some countries. With the availability of food the people started taking excess of food with the same eating habits as it used it be there at the time of famine and hunger period (that one eats fast). Moreover there were no spoons available and people used to make fold of bread to lift the vegetables and curry. With the result, one gallops food in few minutes which is the root cause of so many diseases.

According to the technique of present invention, if one just takes a small piece of bread and takes salad, and eats vegetables, cereals with spoon and chew this properly even for a small piece of breads it takes one to two minutes for proper chewing and eating. So one may take at least 20 to 50 minutes for the food and one cannot over eat. The person gets satisfied and remains more active and energetic.

This concept will decrease the burden of so many diseases, problems of early graying of hairs and aging. No one will eat food in a faulty way again in the future.

Human mind is very intelligent. Majority of humans are not doing the mistake consciously. If it is known to the brain, it will never allow this mistake to again & obesity/overweight/underweight/metabolic syndrome can be prevented or reversed.

If person follows the technique of present invention and eats one meal in 20 to 50 minutes, the signals reach the brain at appropriate time and food gives more energy even if consumed in lesser quantity. One feels satiety and after that safer that one can not overeat. This will solve many problems of food demand supply malnutrition, under nutrition and metabolic syndrome.

Normally there is some diversion of hypertension blood supply from the vital organs to the stomach, intestine and splanchnic circulation with overeating this diversion becomes profound and these organs become hypoperfused and less of nutrients. One feels drowsy—this is the cause for postprandial angina. But with overeating, this diversion become marked leading on to further hypoperfusion of the vital organs Postprandial hypoxia.

Obesity is also the cause of many of heart problems including heart attack, sudden cardiac death/arrhythmia. By eating with the help of brain signals the food is always taken according to the need. With the result, there is never overeating and level of the respiration is always deep and there is movement of the rectum and, oblique muscles which leads on to their movement and Abdominal (waist) and visceral fat decreases improving waist to hip ratio which is first to become normal. With overeating Basal Metabolic Rate (BMR) increase which increases the heart rate, respiratory rate, and thermal loss. With the result, energy loss becomes more than energy conserved and some of there persons become undernourished and underweight. These persons always remain exhausted and fatigued and go on eating again and again. But eating with the brain signals these requirements for wheat/rice/equivalent food decreases to approximately 20 to 50%.

Technique of the Present Invention:

Majority of the individuals mix, bread, vegetables and cereals and then eat with the hand. Many make bread to lift the vegetables and curry and cereals. With the result, the bite of bread become more and overeating occurs (In Asians especially) and all overweight persons across the globe. Many taken full spoon of rice and hurriedly gulp the food immediately resultantly in overeating/obesity. In Asian if instead of one takes bread in the hand preferably in the left hand and spoon in the right hand and takes small bite with the incisors and eats vegetables and cereals with pieces of salad (cucumber, raddish, carrot, onion or any other salad) it takes 1-2 minutes for one cycle bread will take more than 10-15 minutes and later on 2^{nd} half can be taken depending upon the desire and it needed more can be taken. In majority of the cases the persons feels satisfied and can not eat more and overeating can be prevented. Somehow the reason for overeating has occurred because of demand supply mismatch. Also the condition of the countries worsened because of natural calamity and lack of economic stability.

Life span will increase by 10-20 years. This will have multiple effects which can give rise to food for all, health for all and India/developing countries will be developed by 2015. This will also help in global development along with universal peace and prosperity. There will be harmony & eco-balance environment in the nature. It will have multiplies effect in food serving, better health, disease free society, faster economic growth, peace and prosperity in whole of the globe. There will be effect in nature, ecology and wildlife. This may start a new era in the globe as human mankind will be changed demographically, creed, genes and which all will lead to peace and prosperity with crime free society on the globe.

With overeating obesity occurs and many of the genes gets expressed (mutation, transcription, methylation etc.) Eating with the help of brain signals there will be balanced and proper expression of these genes, especially TNF alpha & genes, CRP, insulin resistance gene, Leptin genes. In the next generation there will be new genesis (healthy genes) in the society.

By continuing to eat in faulty way, the blood supply from the vital organs like brain, eyes, heart, lung etc. gets diverted to the stomach and these vital organs get deprived of the blood supply. None of the prior art known so far teaches the technique for such problems and based upon the concepts as being taught in the present invention.

Therefore, the present invention provides a technique of eating with the help of brain signals, said technique comprising of controlling the timing of the signals sent/received by the satiety and hunger centre of brain without the use of any external medications, resulting in balanced control of the blood circulation to the vital organs of the body, so that proper functioning of all organs is achieved and expression, of good gene is regulated and bad genes is diminished.

In an embodiment, the control of the signals sent/received to the satiety center is achieved by slow and controlled eating such that the time taken while eating is increased in the range of 20 min to 50 min per meal with proper chewing.

In another embodiment, the time period of eating is controlled such that the satiety center suppresses the hunger center in better way which gives satiety.

In a further embodiment, said technique results in better control of Alpha Melanocyte Stimulating Harmone (α-MSH) and malonyl-COA expression, which will reduce catecholamine surge/stress hormones in the body, leading to less stress in the body and lesser darkening/decreased melanin deposition in the skin.

In yet another embodiment, said technique is used for the Control of eating disorders; control of blood supply to vital organs and other organs; prevention of relative hypoventilation/hypoxia state and good gene expression.

### EXAMPLES

The following examples are for the purposes of illustration only and therefore should not be construed to limit the scope of present invention:

This idea was worked on a very obese village patient. I did multi-vessel angioplasty and stenting, and was advised diet chart. (AHA II Diet Chart of 1000 calorics) The poor fellow after 3 months follow up reduced only a few kg of weight and found it too difficult to follow this chart to reduce his weight. Alternatively, he was told to follow the technique of present invention of eating with the help of brain signals and was told to cut short his bread and cereals by half and take salads, vegetables and fruits. By following the technique for three months, the reduction in weight was 12 kg. There was also an increase in energy, the person felt more active, satisfied, breathing became deeper and there was also an increase in concentration.

Advantages of the Present Invention:
More than 100 diseases can be prevented;
Millions of sudden cordial deaths can be saved, as the risk of SCD becomes two fold if BMI becomes more than 30;
Millions of heart attack, fatal, and non-fatal can be prevented;
Millions of man-power loss can be prevented;
Millions of metabolic syndrome and diabetes can be prevented and controlled;
Millions of blindness and stroke can be prevented;
Billions-trillions of money can be saved.

I claim:

1. A technique of eating with the help of brain signals, said technique comprising of controlling the timing of the signals sent/received by the satiety and hunger centre of brain without the use of any external medications, resulting in balanced control of the blood circulation to the vital organs of the body, so that proper functioning of all organs is achieved and expression of good gene is regulated and bad genes is diminished.

2. The technique as claimed in claim 1, wherein the control of the signals sent/received to the satiety center is achieved by slow and controlled eating such that the time taken while eating is increased in the range of 20 min to 50 min per meal with proper chewing.

3. The technique as claimed in claim 1, wherein the time period of eating is controlled such that the satiety center suppresses the hunger center in better way which gives satiety.

4. The technique as claimed in claim 1, wherein said technique results in better control of Alpha Melanocyte Stimulating Harmon (α-MSH) and malonyl-COA expression, which will reduce catecholamine surge/stress hormones in the body, leading to less stress in the body and lessee darkening/decreased melanin deposition in the skin.

5. The technique as claimed in claim 1, as and when used for the control of eating disorders; control of blood supply to vital organs and other organs; prevention of relative hypoventilation/hypoxia state and good gene expression.
